(19) United States
(12) Patent Application Publication
(10) Pub. No.: US 2011/0257280 A1
(43) Pub. Date: Oct. 20, 2011

(54) Aqueous Siloxane Formulations for the Production of Highly Elastic Polyurethane Cold Soft Foams

(75) Inventors: Martin Glos, Borken (DE); Matthias Naumann, Greensboro, NC (US); Mladen Vidakovic, Duisburg (DE)

(73) Assignee: Evonik Goldschmidt GmbH, Essen (DE)

(21) Appl. No.: 13/141,754

(22) PCT Filed: Nov. 23, 2009
(86) PCT No.: PCT/EP2009/065601

§ 371 Date: Jun. 23, 2011

(30) Foreign Application Priority Data
Dec. 23, 2008 (DE) 1020080551155

(51) Int. Cl. C08L 75/04; C08K 3/36; C08K 5/19; C08L 83/04; C08J 9/35; B82Y 30/00

(52) U.S. Cl. 521/54; 521/55; 977/779

(57) ABSTRACT

Aqueous cold-cure flexible foam siloxane formulations for use in the production of highly elastic cold-cure flexible polyurethane foams or for use in the production of cold-cure flexible foam activator solutions for highly elastic cold-cure polyurethane foams.

The present invention provides aqueous cold-cure flexible foam siloxane formulations for use in the production of highly elastic cold-cure flexible polyurethane foams or for use in the production of cold-cure flexible foam activator solutions for highly elastic cold-cure polyurethane foams, and the use thereof. The present invention further provides cold-cure flexible foam activator solutions based on the aqueous cold-cure flexible foam siloxane formulations, and also highly elastic cold-cure polyurethane foams obtainable using the aqueous cold-cure flexible foam siloxane formulations and/or cold-cure flexible foam activator solutions.

In the context of this application, cold-cure flexible foam siloxane formulations are understood to mean aqueous compositions comprising siloxanes, which are suitable for production of cold-cure flexible foams. Accordingly, cold-cure flexible foam activator solutions are understood to mean those which, in addition to the cold-cure flexible foam siloxane formulation, contain all other further assistants and additives except the polyol and isocyanate components and are required for production of cold-cure flexible foams.

Cold-cure flexible polyurethane foams are also referred to as “cold-cure foams” or “high-resilience foams” (HR foams).

Highly elastic cold-cure polyurethane foams have various uses for production of mattresses, upholstered furniture or car seats. They are produced by reacting isocyanates with polyols. Specific siloxanes, also called siloxane surfactants, serve to stabilize the expanding foam in the production of cold-cure flexible polyurethane foams. They ensure that a regular cell structure arises, and also that no faults occur in the region under the skin.

To produce the cold-cure flexible polyurethane foams, it is customary to use polyethers, crosslinkers and polyisocyanates, and also customary assistants such as catalysts, stabilizers, blowing agents and the like. A common feature of all these processes is that the system has a high intrinsic stability as a result of early crosslinking of the polyurethane foam. Therefore, it is possible or necessary in many cases to dispense with the use of a polysiloxane-polyether copolymer as an additive which stabilizes the foam against settling.

The siloxanes described here as stabilizers may have different tasks within the foam, for example including cell regulation or cell opening, stabilization, edge zone regulation, prevention of collapse phenomena, promotion of flowability of the foaming mixture, etc.

There is a multitude of production processes for highly elastic flexible polyurethane foams, which have been described in detail in the literature. For instance, publication DE 25 33 074 A1, to which reference is made in full, already reports a multitude of references which describe the industrial scale production of flexible polyurethane foams.

In addition, the production of flexible polyurethane foams is described in Polyurethane Handbook Chemistry Raw Materials Processing Application Properties (Author: G. Oertel), Carl Hanser Verlag, 1985, to which reference is made in full.

The siloxanes used are usually not used in the form of pure substances, but rather incorporated as components into an appropriate formulation, in order to improve the meterability or the processability into the reaction matrix. For blending of the siloxanes, different organic substances are used as a kind of solvent for such formulations. Published specification DE 2 356 443 describes a multitude of organic solvents for the production of aralkyl-modified formulations containing siloxane oils. These are often surfactant substances.

WO 2008/071497 describes water-based formulations of water-insoluble siloxanes for production of cold-cure polyurethane foams, said formulations comprising conventional molecular surfactants.

In DE 3626297 C1, the siloxanes used are blended with a short-chain polyether based on propylene oxide before they are sent to foaming.

However, organic solvents entail a number of disadvantages, for example problematic toxicological classification, with excessive flammability of the formulation and/or unwanted emission of organic solvent residues of the resulting foam. In addition, the organic solvents can adversely affect the properties of the cold-cure flexible polyurethane foam, such as pore structure, elasticity and the like.

The use of water has the advantage over organic solvents that water is available to a virtually unlimited degree, is nontoxic and is nonflammable. In addition, it is possible to purify water easily and dispose of it without any technical complexity. A further advantage is that the safety regulations for the storage of water are negligibly minor.

It is an object of the present invention to provide cold-cure flexible foam siloxane formulations comprising water-insoluble siloxane compounds, and also cold-cure flexible foam activator solutions, which avoid at least one of the above disadvantages.

It is a further object of the present invention to provide a cold-cure flexible foam siloxane solution which has a maximum proportion of water and siloxane, since these two components are required for the foaming. The proportion of substances such as surfactants or organic solvents which are not needed for the foaming is therefore reduced in accordance with the invention to the minimum possible.

It has now been found that this object can be achieved by stabilizing the formulation using particles which are nanoscale and/or nanostructured in at least one dimension, which assume the interface-stabilizing function of a surfactant or emulsifier. Such emulsions are referred to in the context of this invention as particulate emulsions.

The cold-cure flexible foam siloxane formulation can be converted to a cold-cure flexible foam activator solution using further assistants and additives except the polyol and isocyanate components which are required for production of the cold-cure flexible polyurethane foams.

The cold-cure flexible foam siloxane formulation should have a maximum proportion of water and water-insoluble polysiloxane compound.

More particularly, the sum of water-soluble polysiloxane compound and water should be greater than 50% by weight based on the overall composition.

It is optionally possible to additionally use further surface-active substances. Advantages over the conventional emulsion here are the expected lower emissions of volatile organic components, and correspondingly of VOCs (fogging), from the finished foam, which can originate from blend components or surface-active substances. Moreover, emulsions stabilized in the solid state are known for their good stability with respect to droplet coalescence; merely creaming or sedimentation of the droplets of the inner phase as a function of the droplet size, of the density difference between the outer and inner phases and on the viscosity of the outer phase can be observed. Typically, simple stirring can rehomogenize a creamed/sedimented emulsion stabilized in the solid state; it is therefore possible to expect good storability of such emulsions.

It has been found that, surprisingly, siloxanes in the form of an emulsion stabilized in the solid state (o/w) are just as effective in the foaming as siloxanes in a conventional emulsion or a solution. Astonishingly, in spite of the coverage of the interfaces from the emulsion stabilized in the solid state, it is possible to release the siloxane from the start of the foaming. Since the interfaces between inner and outer phases in emulsions stabilized in the solid state are “covered” with particles, the stability thereof is much higher than in the case of use of interface-active molecules as emulsifiers. For this reason, it is surprisingly possible to substantially or even completely dispense with the addition of emulsifiers.

In the course of foaming, the siloxanes present in the inner phase have to lower the surface tension of the overall system in order to ensure good nucleation, in order that a corresponding fine-cell and regular foam can form.

Aqueous emulsions stabilized in the solid state were described in 1907 by S.U. Pickering (“Emulsions”, Spencer Umfreville Pickering, Journal of the Chemical Society, Transactions (1907), 91, 2001-2021) and are considered to be particularly stable with respect to coalescence. For example, DE 10 2004 014 704 describes the production of emulsions which have been stabilized with particles obtained by pyrogenic means. A good overview of the properties of such stabilizing solid particles can be found in “Particles as surfactants—similarities and differences” by Bernhard P. Binks (Current opinion in colloid & interface science, 7 (2002), 21-41). The prior art also includes what are called “Janus particles”, amphiphilic particles with a hemispherically modified surface, as described, for example, in FR 2 808 704. Particularly suitable for emulsion stabilization are nanoscale, predominantly inorganic particles, for example silica particles, which are commercially available, for example, as “LUDOX®” in the form of aqueous sols or dispersions from Grace Davison. A mechanism of stabilizing action which is discussed in the literature is the agglomeration of the particles and the accumulation of the agglomerates at the water/oil interface (“The mechanism of emulsion stabilization by small silica (LUDOX®) particles”, Helen Hassander, Beatrice Johansson, Bertil Tornell, Colloids and Surfaces, 40, (1989), 93-105).

The process according to the invention also has the advantage that, in the course of production of the siloxane emulsions using particulate emulsifiers, only small amounts, if any, of conventional emulsifiers are needed, which could be troublesome at a later stage in applications.

For this purpose, the emulsifiers may be particles which are preferably nanoscale in at least one dimension and/or nanostructured particles or nanoobjects, which are more preferably selected from the group of the semimetal oxides, metal oxides (for example of Al, Si, Ti, Fe, Cu, Zr, B, etc.), mixed oxides, nitrides, carbides, hydroxides, carbonates, silicates, silicone resins, silicones and/or silica, and/or organic polymers, where all of these particle classes mentioned may optionally be hydrophobized or partly hydrophobized, for example with at least one compound from the group of the silanes, siloxanes, quaternary ammonium compounds, cationic, amphoteric, anionic or nonionic surface-active substances or surfactants, cationic polymers and fatty acids or the anions thereof. In the context of the present invention, nanoobjects are understood to mean materials which are nanoscale in one, two or three external dimensions; preferably at least one dimension has a size of 1 to 100 nm, for example nanoplatelets, nanorods and nanoparticles. In the context of the present invention, nanostructured particles are understood to mean materials or particles which have an internal nanoscale structure. Typical representatives are, for example, aggregates and agglomerates of nanoobjects.

Particularly preferred particulate emulsifiers have a mean primary particle size in at least one dimension of less than ≦1000 nm, preferably less than ≦500 nm and more preferably from 1 to 100 nm. The primary particle size can be determined in the manner known to the person skilled in the art, for example by means of SEM, TEM, DLS or static light scattering, etc. Preferably, the primary particle size is determined by optical evaluation of an image produced by transmission electronmicroscopy.

Especially in the case of use of particulate emulsifiers, it may be advantageous when, in one step of the production process, the production of the emulsion is performed with the addition of one or more coemulsifiers. The coemulsifiers used in the process according to the invention may especially be those compounds which interact with the solid-state emulsifier particles, preferably those which are adsorbed on the hydrophobizing solid-state emulsifier particles. The coemulsifiers used in the process according to the invention may generally be cationic, nonionic or anionic, but also amphoteric, surface-active substances which are adsorbed on the solid-state emulsifier particles. In the process according to the invention, it is accordingly possible to use, as coemulsifiers for emulsifier particles with negative zeta potential, especially compounds selected from the group of the cationic surfactants. The cationic coemulsifiers used may, for example, be the products obtainable by the trade names VARISOFT 470 P, VARISOFT TC-90, VARISOFT 110, VARISOFT PATC, AROSURF TA-100, ADOGEN 442-100 P, ADOGEN 432, ADOGEN 470, ADOGEN 471, ADOGEN 464, VARIQUAT K 300, VARIQUAT B 343, VARIQUAT 80 ME, REWOQUAT 3690, REWOQUAT WE 15, REWOQUAT WE 18, REWOQUAT WE 28 or REWOQUAT CR 3099 from Evonik Goldschmidt GmbH (the products written in capital letters are registered trademarks of Evonik Goldschmidt GmbH). Preference is given to using, in the process according to the invention, cetyltrimethylammonium bromide or chloride (VARISOFT 300) or VARISOFT PATC as cationic coemulsifiers. For emulsifier particles with positive zeta potential, the coemulsifiers used may especially be compounds selected from the group of the anionic surfactants, for example sodium laurylsulfate, sodium lauryl ether sulfate, sulfosuccinates such as REWOPOL SB DO 75, alkyl ether phosphates, fatty acid anions, n-acylamino acids, olefinsulfonates or alkylbenzenesulfonates. It is equally possible to use amphoteric or nonionic surface-active substances or surfactants for this purpose. These compounds may exert hydrophobizing action, but alone—without particulate emulsifier—are incapable of displaying the inventive action. However, the coemulsifiers can promote or else optimize the action of the particulate emulsifier.

It may be particularly advantageous when the modifying agent has at least one functional group which can enter into a covalent, ionic or coordinate bond or hydrogen bonds with the surface to be modified. These functional groups may, for example, be carboxylic acid groups, acid chloride groups, ester groups, nitrile and isonitrile groups, OH groups, SH groups, epoxy groups, anhydride groups, acid amide groups, primary, secondary and tertiary amino groups, Si—OH groups, hydrolyzable radicals of silanes (Si—OR) or CH-acidic moieties, as, for example, in β-dicarbonyl compounds, for example acetylacetone, 2,4-hexanedione, 3,5-heptanedione, diacetyl or acetoacetic acid. It is likewise also possible for more than one such group to be present in the modifying agent, as, for example, in betaines, amino acids, for example glycine, alanine, β-alanine, valine, leucine, isoleucine, arginine and aminocaproic acid, and also in EDTA. Carboxylic acids for surface modification are, for example, fatty acids, formic acid, acetic acid, propionic acid, butyric acid, pentanoic acids, hexanoic acid, acrylic acid, adipic acid, succinic acid, fumaric acid, itaconic acid, stearic acid, hydroxystearic acid, ricinoic acid and polyethercarboxylic acids, and the corresponding anhydrides, chlorides, esters and amides thereof, for example methoxyacetic acid, 3,6-dioxaheptanoic acid and 3,6,9-trioxadecanoic acid, and the corresponding acid chlorides, esters and amides.

In addition to the at least one functional group which can enter into a bond with the surface of the particle, the modifying agent may additionally have further radicals which modify the properties of the particle.

Such radicals, or else parts thereof, may, for example, be hydrophobic or hydrophilic or bear one or more functional groups in order in this way to compatibilize the silicone particles with the surrounding medium, to inertize them or to make them reactive, which also includes an attachment to the surrounding matrix. These functional groups can, for example, be selected from the range of the alkyl, aryl, alkaryl, aralkyl, fluoroalkyl, hydroxy, alkoxy, polyalkoxy, epoxy, acryloyloxy, methacryloyloxy, acrylate, methacrylate, carboxyl, amino, sulfonyl, sulfate, phosphate, polyphosphate, phosphonate, amide, sulfide, hydrogensulfide, haloalkyl, haloaryl and acyl groups.

The inventive emulsions are preferably produced substantially free of further coemulsifiers. If, nevertheless, coemulsifiers are used additionally, 0 to 10% by weight, based on the particulate emulsifier, preferably 0.05 to 8% by weight and more preferably 0.2 to 5% by weight is used.

The invention further provides compositions which are free of nonparticulate emulsifiers.

If it is not possible to dispense with a nonparticulate emulsifier for performance reasons, this emulsifier is present in contents of >0 to less than 10% by weight.

It is also possible to modify the solid-state emulsifier particles with silanes and organopolysiloxanes, preferably to obtain partly hydrophobized particles which have to be introduced by dispersion with application of high shear forces. Preference is given here to using oxidic particles, for example pyrogenic or precipitated silica particles, or those produced by the Stoeber process, but this does not rule out the use of other particulate materials.

When the surface modification is performed with silanes, it is possible with preference to use hydrolyzable organosilanes which additionally have at least one nonhydrolyzable radical. Such silanes are represented by the general formula (IV)

RₙSiX₍₄₋ₙ₎ (IV)

where

R=identical or different nonhydrolyzable groups,

X=identical or different hydrolyzable groups or hydroxyl groups and

n=1, 2, 3 or 4.

In the general formula (IV), the hydrolyzable X groups may, for example, be H, halogen (F, Cl, Br, I), alkoxy (preferably methoxy, ethoxy, isopropoxy, n-propoxy or butoxy), aryloxy (preferably phenoxy), acyloxy (preferably acetoxy or propionyloxy), acyl (preferably acetyl), amino, monoalkylamino or dialkylamino groups. In addition, the nonhydrolyzable R radicals in the general formula (IV) may be radicals either with or without functional groups. For instance, R in the general formula (IV) without functional groups may, for example, be an alkyl, alkenyl, akynyl, aryl, alkylaryl or aralkyl radical. The R and X radicals may optionally have one or more customary substituents, for example halogen or alkoxy. In the case of radicals of the general formula (IV) with a functional group, the functional group can, for example, be selected from the range of the epoxy (e.g. glycidyl or glycidyloxy), hydroxyl, ether, amino, monoalkylamino, dialkylamino, optionally substituted aniline, amide, carboxyl, acryloyl, methacryloyl, acryloyloxy, methacryloyloxy, mercapto, cyano, alkoxy, isocyanato, aldehyde, alkylcarbonyl, acid anhydride, phosphate and polyphosphate groups. These functional groups may be bonded to the silicon atom via alkylene, alkenylene or arylene bridging groups which may be interrupted by oxygen or NH groups. These divalent bridging groups and any substituents present, as in the case of alkylamino groups, may be derived from the corresponding monovalent alkyl, alkenyl, aryl, aralkyl and alkaryl radicals. Of course, the R radical may also have more than one functional group. Nonhydrolyzable R radicals of the general formula (IV) with functional groups may be selected from the range of the glycidyl or glycidyloxyalkylene radicals, for example β-glycidyloxyethyl, γ-glycidyloxypropyl, δ-glycidyloxy-propyl, ε-glycidyloxypenyl, ω-glycidyloxyhexyl or 2-(3,4-epoxycyclohexyl)ethyl, the methacryloyloxy-alkylene and acryloyloxyalkylene radicals, for example methacryloyloxymethyl, acryloyloxymethyl, methacryloyl-oxyethyl, acryloyloxyethyl, methacryloyloxypropyl, acryloyloxypropyl, methacryloyloxybutyl or acryloyloxybutyl, and the 3-isocyanatopropyl radical.

In addition, it is also possible to use silanes with at least partly fluorinated alkyl radicals, for example 3,3,4,4,5,5,6,6,7,7,8,8,8-tridecafluorooctyl or 3,3,3-trifluoropropyl groups.

It is likewise possible, especially in the case of oxidic particles, for example colloidal silica as obtainable, for example, from Grace Davison as LUDOX®, to perform a surface modification with siloxanes and organopolysiloxanes. This can be done by the use of dimethylpolysiloxanes end-capped with trimethylsiloxy groups, cyclic dimethylpolysiloxanes, α,ω-dihydroxy-polydimethylsiloxanes, cyclic methylphenylsiloxanes, methylphenylpolysiloxanes end-capped with trimethylsiloxy groups, or of dimethylsiloxane-methylphenylsiloxane copolymers end-capped with trimethylsiloxy groups, optionally in the presence of a suitable catalyst (for example ammonium carbamate or alkali hydroxides) and optionally also elevated temperatures.

The surface modification with polysiloxanes or organopolysiloxanes can be effected covalently, but also adsorptively; examples of such substance classes are organopolysiloxanes modified terminally and/or in comb positions with polyether or polyester chains. It is likewise possible to use monofunctional polysiloxanes for surface modification of the particles, for example α-halo-, α-alkoxy- and α-hydroxydimethylpolysiloxanes end-capped with trimethylsilyl groups.

Such a surface modification can be accomplished by the use of dimethylpolysiloxanes end-capped with trimethylsiloxy groups, cyclic dimethylpolysiloxanes, α,ω-dihydroxypolydimethylsiloxanes, cyclic methylphenylsiloxanes, methylphenylpolysiloxanes end-capped with trimethylsiloxy groups, and/or of dimethylsiloxane-methylphenylsiloxane copolymers end-capped with trimethylsiloxy groups, optionally in the presence of a suitable catalyst (for example ammonium carbamate or alkali metal hydroxides) and optionally also elevated temperatures.

The surface modification with organopolysiloxanes can be effected covalently or adsorptively; examples of such substance classes are organopolysiloxanes modified terminally and/or in comb positions with polyether or polyester chains. It is likewise possible to use monofunctional polysiloxanes for surface modification of the particles, for example α-halo-, α-alkoxy- and α-hydroxydimethylpolysiloxanes end-capped with trimethylsilyl groups.

In the case of use of dispersions or sols of particles for emulsion production in the context of the process according to the invention, an emulsion is produced with a mean particle size of 0.01 to 1000 μm, preferably 0.1 to 500 μm and more preferably 1 to 100 μm.

The droplet size can be estimated with the aid of light microscopy (down to approx. 1 μm as the lower limit) by measuring the smallest and greatest droplet diameter in the field of view in each case; at least 10×10 droplets should be present in the field of view. In addition, it is possible to determine the droplet size distributions by methods of static and dynamic light scattering which are familiar to those skilled in the art.

The term “particulate emulsion” is understood hereinafter to mean the inventive aqueous siloxane composition, stabilized using particulate additives or particulate emulsifiers.

The invention further provides a process for producing a particulate emulsion with droplet sizes within the preferred range, in which, in the simplest case, the particulate emulsifier is processed with expenditure of shear forces, together with the liquid components, to give an inventive composition.

The invention further provides a process in which not only particles but also coemulsifiers are used. In this case, it may be advantageous not to add the coemulsifier(s) until a preliminary emulsion has been produced in a component step a1). This preliminary emulsion can be obtained by emulsifying a mixture of siloxanes of the general formula (I), water and emulsifier, preferably particulate emulsifier and more preferably particulate SiO₂ and most preferably LUDOX® SM-AS from Grace Davison, with application of high shear forces, as is possible, for example, with a rotor-rotor system. A suitable rotor-rotor system is supplied, for example, as a Co-Twister homogenizer from Symex.

In a further step a2), the coemulsifier(s) is/are added to this preliminary emulsion. The coemulsifiers can be added as a pure substance or in the form of a solution, for example of an aqueous solution. The addition of the coemulsifier to the preliminary emulsion can effectively freeze the droplet size of the droplets present in the preliminary emulsion. At the time of coemulsifier addition, the emulsifier particles are partly hydrophobized and cover the interface between the inner and outer phases of the preliminary emulsion.

The weight ratio of particulate emulsifier to coemulsifiers is preferably up to 200:1, more preferably up to 50:1. The added amounts of emulsifier and coemulsifier can roughly preset the droplet size distribution of the emulsion.

Examples of further substances which can additionally be used for particle modification include salts of primary, secondary or tertiary amines, alkyltrimethylammonium salts, dialkyldimethylammonium salts, trialkylmethylammonium salts, tetraalkylammonium salts, alkoxylated alkylammonium salts, alkylpyridinium salts or N,N-dialkylmorpholinium salts. Anionic surface-active compounds may, for example, be selected from salts of aliphatic carboxylic acids, alkylbenzenesulfonates, alkylnaphthylsulfonates, alkylsulfonates, dialkyl sulfosuccinates, α-olefin-sulfonates, salts of α-sulfonated aliphatic carboxylic acids, N-acyl-N-methyltaurates, alkyl sulfates, sulfated oils, polyethoxylated alkyl ether sulfates, polyethoxylated alkylphenyl ether sulfates, alkyl phosphates, polyethoxylated alkyl ether sulfates, polyethoxylated alkylphenyl ether sulfates and condensates of formaldehyde and naphthylsulfonates. Amphoteric surface-active compounds can, for example, be selected from N,N-dimethyl-N-alkyl-N-carboxy-methylammonium betaines, N,N-dialkylaminoalkylene carboxylates, N,N,N-trialkyl-N-sulfoalkyleneammonium betaines, N,N-dialkyl-N,N-bispolyoxyethyleneammonium sulfate ester betaines, 2-alkyl-1-carboxymethyl-1-hydroxyethylimidazolinium betaines. Nonionic surface-active compounds may, for example, be selected from polyethoxylated alkyl ethers, polyethoxylated alkenyl ethers, polyethoxylated alkylphenyl ethers, polyethoxylated polystyrene phenyl ethers, polyoxyethylene-polyoxypropylene glycols, polyoxyethylene-polyoxypropylene alkyl ethers, partial esters of aliphatic carboxylic acids with polyfunctional alcohols, for example sorbitan esters, aliphatic glyceryl esters, aliphatic polyglyceryl esters, aliphatic decaglyceryl esters, (mixed) aliphatic esters of ethylene glycol/pentaerythritol, (mixed) aliphatic esters of propylene glycol/pentaerythritol, polyethoxylated aliphatic partial esters of polyfunctional alcohols, for example polyethoxylated aliphatic sorbitan partial esters, ethoxylated aliphatic glyceryl esters, mixed ethoxylated/aliphatically esterified acids, aliphatic carboxylic esters of polyglycerols, polyethoxylated castor oil, diethanolamides of aliphatic carboxylic acids, polyethoxylated alkylamines, aliphatic partial esters of triethanolamine, trialkylamine oxides and polyalkoxylated organopolysiloxanes. Such dispersing additives may, for example, be selected from the product portfolio of Evonik Goldschmidt GmbH, which are available there, for example, under the “Tego® Dispers” or “Tegopren®” names. The content of such surface-active substances may be between 0.1 and 50% by weight, preferably between 1 and 30% by weight, based on the dispersion.

If particularly fine emulsions or narrow droplet size distributions are to be achieved, the emulsions can be aftertreated in a subsequent step a3), optionally by means of gap, die or slot homogenizers, or else, for example, a Microfluidizer from Microfluidics.

In a particularly preferred embodiment, the particulate emulsion is aftertreated by means of the Microfluidizer. This involves dispersing the particulate emulsion in a homogenizer with an interaction chamber. The dispersion is preferably effected in at least one interaction chamber which contains microchannels, preferably with a capillary thickness (internal diameter) of 50 to 500 μm and preferably at a pressure of 50 to 1000 bar, preferably 100 to 800 bar, more preferably 200 to 600 bar, and subsequent decompression of the mixture to ambient pressure, for example in an outlet reservoir. This preferably establishes one of the abovementioned preferred droplet sizes. It may be advantageous when two or more interaction chambers connected in series are used. In this way, the desired droplet size can be established more easily.

Preference is given to using interaction chambers which have at least one microchannel with a capillary thickness of 100 to 300 μm. Particular preference is given to using interaction chambers which have at least one microchannel, and preferably exclusively microchannels, which have at least one deflection bend.

It is likewise possible to add to the particulate emulsions further functional substances which are advantageous for the production and use of the polyurethane foams thus produced and are known to those skilled in the art. The tasks of these functional substances may consist, for example, in acting as antifreezes, thickeners, biocides, UV stabilizers, cell openers or reaction accelerators.

“Solid-state emulsifier” is understood hereinafter to mean a particle which is nanoscale in at least one dimension, optionally with an appropriate coemulsifier.

The object of the present invention is achieved by an aqueous cold-cure flexible foam siloxane formulation for use in the production of cold-cure flexible polyurethane foams or for use in the production of cold-cure flexible foam activator solutions for cold-cure polyurethane foams, said aqueous cold-cure flexible foam siloxane formulation comprising the following components:
a) ≧0.1% by weight to ≦80% by weight, preferably 5 to 70% by weight and more preferably 10 to 60% by weight, of at least one water-insoluble polysiloxane compound having a molecular weight of at least ≧300 g/mol and ≦10 000 g/mol,
b) 2% by weight to 99% by weight, preferably 30 to 95% by weight, more preferably 50 to 90% by weight and especially preferably 70 to 85% by weight of water,
c) 0.05% by weight to 40% by weight, preferably 0.3 to 30% by weight, more preferably 0.5 to 20% by weight and especially preferably 1 to 10% by weight of solid-state emulsifier,
d) ≧0% by weight to 25% by weight, preferably 5 to 20% by weight, more preferably 10 to 20% by weight, of functional substances, and
e) optionally ≧0% by weight to 80% by weight, preferably ≧0% by weight to 20% by weight, more preferably 10 to 20% by weight, of water-soluble siloxane(s),
where the proportion by weight of the aforementioned components is selected such that the total proportion by weight of the components is not more than 100% by weight, based on the aqueous cold-cure flexible foam siloxane formulation.

The inventive cold-cure flexible foam siloxane formulation may contain ≧0.2% by weight to ≦70% by weight, preferably ≧0.5% by weight to ≦60% by weight, more preferably ≧1% by weight to ≦50% by weight, even more preferably ≧2% by weight to ≦40% by weight and additionally preferably ≧3% by weight to ≦30% by weight of at least one water-insoluble polysiloxane compound.

In a preferred embodiment, the sum of water and water-insoluble polysiloxane compound in the cold-cure flexible foam siloxane formulation composition is more than 50% by weight, preferably more than 60% by weight, more preferably more than 70% by weight and especially preferably more than 80% by weight, based on the overall composition.

A further preferred inventive cold-cure flexible foam siloxane composition comprises the following components, which are also described in WO 2008/071497, which is hereby fully incorporated by a reference into this disclosure:
a) 0.1% by weight to 80% by weight of at least one water-insoluble polysiloxane compound having a molecular weight of ≦10 000 g/mol and having the following general formula (I):

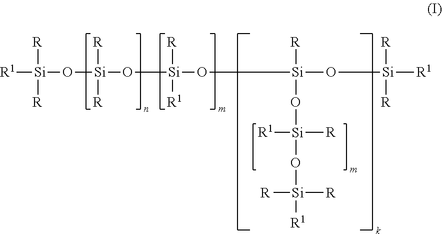

in which
R=identical or different linear, branched, unsaturated or saturated hydrocarbyl radicals having 1 to 50 carbon atoms,
R¹=R, OH, identical or different linear, branched, unsaturated or saturated hydrocarbyl radicals having 1 to 100 carbon atoms, containing at least one heteroatom selected from the group of N, S, O, P, F, Cl, Br and/or I,
n=≧0 to 50,
m=≧0 to 50,
k=≧0 to 10,
b) 2% by weight to 99% by weight, preferably 30 to 95% by weight, more preferably 50 to 90% by weight and especially preferably 70 to 85% by weight of water,
c) 0.05% by weight to 40% by weight, preferably 0.3 to 30% by weight, more preferably 0.5 to 20% by weight and especially preferably 1 to 10% by weight of solid-state emulsifier,
d) ≧0% by weight to 25% by weight, preferably 5 to 20% by weight, more preferably 10 to 20% by weight, of functional substances, and
e) optionally ≧0% by weight to 80% by weight, preferably ≧0% by weight to 20% by weight, more preferably 10 to 20% by weight, of water-soluble siloxane(s),
with the condition that n+m≧2 and n+m≦70, where the proportion by weight of the aforementioned components is selected such that the total proportion by weight of the components is not more than 100% by weight, based on the aqueous cold-cure flexible foam siloxane formulation.

Additionally preferred is an aqueous cold-cure flexible foam siloxane formulation which comprises at least one water-insoluble polysiloxane compound of the general formula (I)

in which
R=identical or different alkyl or aryl radicals, preferably methyl, ethyl or propyl and more preferably methyl,
n=1 to 50, preferably 3 to 40 and more preferably 5 to 25,
m=≧1 to 20, preferably 2 to 15 and more preferably 3 to 10,
k=≧1 to 10, preferably 2 to 8 and more preferably 3 to 6.

Preference is additionally given to an aqueous cold-cure flexible foam siloxane formulation which comprises at least one water-insoluble polysiloxane compound of the general formula (I) in which at least R¹ is a side chain, of the general formula (II):

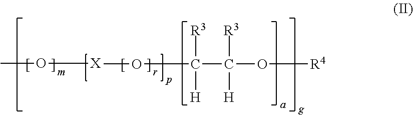

in which
R³ are the same or different and are each H, methyl, ethyl, propyl or phenyl,
R⁴ are the same or different and are each H, alkyl, acyl, acetyl, aryl radical, preferably a monovalent or divalent hydrocarbyl radical having 1 to 30 carbon atoms and preferably a monovalent (g=1) or divalent (g=2) hydrocarbyl radical having 1 to 30 carbon atoms with at least one heteroatom selected from the group of N, S, O, P, F, Cl, Br and/or I, where, in the case that g=2, two compounds of the general formula (I) are joined by the radical of the formula (II),
X is a saturated, unsaturated, branched, cyclic, difunctional hydrocarbon having 1 to 30 carbon atoms, which may also contain heteroatoms such as N or 0,
a=≧0 to ≦30, preferably 1 to 25 and more preferably 2 to 20,
g=1 or 2,
p=0 or 1,
r=0 or 1,
s=0 or 1.

In yet a further preferred embodiment of the present invention, the water-insoluble polysiloxane compound usable in accordance with the invention has the following formula (III):

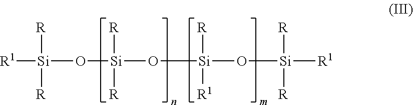

in which
R are the same or different and are each methyl or ethyl,
R¹ are R, OH, or are the same or different and are each alkyl radicals containing hydroxyl, amino, chlorine or cyano groups, preferably hydroxyalkyl, aminoalkyl, chloropropyl or cyanopropyl,
n=≧2 to 30, preferably 3 to 25 and preferably 4 to 25,
m=≧0 to ≦5.

It is obvious to the person skilled in the art that the water-insoluble polysiloxane compounds usable in accordance with the invention will be in the form of a mixture, the distribution of which is determined essentially by statistical laws. The different structural units in the above formulae (I), (II) and (III) may be arranged randomly or in blocks. The values for a, g, n, m, k, p, r and/or s therefore correspond to mean values.

The water-insoluble polysiloxane compounds usable in the inventive composition are suitable for the production of cold-cure flexible polyurethane foams. To produce the cold-cure flexible polyurethane foams, 0.1 to 5 parts by mass of the inventive composition are used per 100 parts by mass of polyol.

Thus, the proportion of the water-insoluble polysiloxane compounds usable in accordance with the invention is determined to be 0.005 to 5.0 parts by mass, preferably 0.01 to 2 parts by mass, of water-insoluble polysiloxane compounds per one hundred parts by mass of polyol.

In the context of this invention, the term “water-insoluble polysiloxane compounds” is understood to mean polysiloxane compounds of which a maximum of 5 g can be stirred homogeneously into 100 ml of double-distilled water at 23° C. in a 250 ml beaker by means of a Teflon-coated stirrer bar (length 3 cm) at a stirrer speed of 200 rpm over a period of 1 hour, without any phase separation forming after the mixture has been left to stand over a period of at least 100 days.

In the context of this invention, the term “water-soluble polysiloxane compounds” is understood to mean polysiloxane compounds of which >5 g can be stirred homogeneously into 100 ml of double-distilled water at 23° C. in a 250 ml beaker by means of a Teflon-coated stirrer bar (length 3 cm) at a stirrer speed of 200 rpm over a period of 1 hour, without any phase separation forming after the mixture has been left to stand over a period of at least 100 days.

The functional substances used may especially be those which are suitable for improving the production and use of the polyurethane foam. These are known to the person skilled in the art and may be selected from the group comprising, for example: thickeners, antifreezes, cell openers, reaction accelerators, organic solvents and/or biocides.

For stabilization and establishment of the desired viscosity, it is also possible to add further functional substances as thickeners to the emulsions. These include, for example, solvents miscible with the dispersion medium, or else soluble polymers, for example xanthan gum, guar flour, carboxymethyl-cellulose, polyvinyl alcohol, polyvinylpyrrolidone, carboxyvinyl polymers, polyacrylates, hydroxyethyl-cellulose, polyethyleneimines, polyethoxylated glycol stearate, and also clays, sheet silicates, pyrogenic oxides such as AEROSIL® (Evonik Degussa), precipitated silicas such as SIPERNAT® (Evonik Degussa), diatomaceous earth (kieselguhr), fumed silica, quartz flour, titanium dioxide, zinc oxide, cerium oxide, iron oxide, carbon black, graphite, carbon nanotubes or nanofibers, aluminosilicates, alkaline earth metal carbonates, aluminum trihydroxide, magnesium dihydroxide or other customary solids known from the prior art, and any of the substances mentioned after surface modification with organosilicon compounds such as trimethylchlorosilane, hexamethyldisilazane, (meth) acryloyloxypropyltrialkoxysilanes, aminopropyltrialkoxysilanes, polydimethylsiloxanes, polysiloxanes which bear Si-H groups, or pure carboxylic acids, chelating agents or fluoropolymers, hydroxy fatty acid glycerides, hydroxy fatty acids, aluminum tristearate, polyolefin waxes, polyacrylate-based compounds, preferably carbomers, Carbopols or cellulose ethers, preferably Tylose® products, obtainable from Shinetsu, polyurethane-based compounds such as Viscoplus® products, obtainable from Evonik Goldschmidt GmbH, and amide waxes. These solids may serve, for example, as fillers to achieve particular mechanical properties, as UV stabilizers, as pigments, as antistatic additives or else, for example, to achieve ferromagnetic properties.

The antifreezes include, for example, salts such as NaCl, CaCl₂, potassium acetate or potassium formate, or else short-chain alcohols or glycols, such as ethanol, isopropanol, butyl glycol, butyl diglycol, ethylene glycol, diethylene glycol, dipropylene glycol or propylene glycol, or else higher homologs, known as polyalkylene glycols, and also urea or glycerol.

The biocides used may be commercial products, for example chlorophene, benzoisothiozolinone, hexahydro-1,3,5-tris(hydroxyethyl-s-triazine), chloromethylisothiazolinone, methylisothiazolinone or 1,6-dihydroxy-2,5-dioxohexane, which are known by the trade names BIT 10, Nipacide BCP, Acticide MBS, Nipacide BK, Nipacide CI, Nipacide FC.

The cell openers used may be the substances known to those skilled in the art, for example polyethers with a high proportion of polyethylene glycol (high EO content) as described in the documents U.S. Pat. No. 4,863,976, U.S. Pat. No. 4,347,330. Commercially available examples are Voranol CP 1421 from Dow Chemicals, or polyethylene glycol 8000, polyethylene glycol 12000, polyethylene glycol 20000 or polyethylene glycol 35000 from Clariant. These cell openers can be used particularly advantageously in the inventive composition since phase separation occurs in the emulsions known to date, without use of particles as a surfactant, in the case of addition of the substances with high EO content.

Owing to the raw materials used, cold-cure foams have very typical physical properties which distinguish them from hot-cure foams.

The cold-cure foams have:
(a) a latex-like feel,
(b) an increased elasticity compared to the conventional hot-cure foams, which is why these foams are also referred to as “high-resilience foams” (HR foams),
(c) compressive strength characteristics different than hot-cure foam (higher sag factor) and hence have better seating comfort when used as upholstery material (furniture foam),
(d) good long-term use properties with only low fatigue tendency, which is of great interest especially in the automotive sector,
(e) due to their melting behavior, better flame resistance than conventional hot-cure foams,
(f) a more favorable energy balance and shorter cycle times in mold foaming.

A further essential feature of the cold-cure foams is the ball rebound. A method for determining ball rebound is described, for example, in ISO 8307. This involves allowing a steel ball of fixed mass to fall from a particular height to the specimen and then measuring the height of rebound in % of the drop height. Typical values for a cold-cure flexible foam are in the region of more than 55%. In contrast, hot-cure foams or polyurethane ester foams, also referred to hereinafter as ester foams, had only rebound values of not more than 30% to 48%.

The crucial difference from the hot-cure foam in cold-cure foam production is that, firstly, high-reactivity polyols and optionally also low molecular weight crosslinkers are used, and the function of the crosslinker can also be assumed by higher-functionality isocyanates. Thus, the isocyanate groups react with the hydroxyl groups as early as the expansion phase (CO₂ formation from —NCO and H₂O) of the foam. This rapid polyurethane reaction leads, via the viscosity rise, to a relatively high intrinsic stability of the foam during the blowing operation.

Cold-cure flexible polyurethane foams are consequently highly elastic foams in which edge zone stabilization is of great importance. Due to the high intrinsic stability, the cells have often not been opened to a sufficient degree at the end of the foaming operation, and mechanical pressure still has to be applied. In this context, the applied force needed gives a measure of the open-cell content. Desirable foams have a high open-cell content and require only low applied forces. In contrast to hot-cure flexible polyurethane foams, mold foaming produces cold-cure flexible polyurethane foams at a temperature of, for example, ≦90° C.

The cold-cure flexible foam siloxane formulation and/or cold-cure flexible foam activator solution which comprises water-insoluble polysiloxanes as stabilizers in accordance with the invention has advantageous properties for control of cell size and cell size distribution, and also edge zone regulation.

The siloxanes used thus do not only assume the stabilizing function, but can also influence cell opening, cell size distribution or flowability of the foam.

In the block foaming of cold-cure flexible polyurethane foams, apart from foam stabilization and regulation of cell size distribution, the actual problem is the necessary cell opening at the correct time and to the correct degree. When the cells open at too early or too late a stage, the foam can collapse or shrink. If a foam does not have a sufficient open-cell content, mechanical pressurization can present problems.

Additional requirements occur in the production of a cold-cure flexible polyurethane foam body, since the expanding reaction mixture, to fill the entire mold volume, has to overcome relatively long flow paths. It is easily possible here for entire cell assemblies to be destroyed at the mold walls or at introduced inserts, such that cavities form under the foam skin. A further critical zone is within the region of the venting orifices. If excess blowing gas flows past the cell assemblies at excessively high speed, this leads to partially collapsed zones.

In an advantageous manner, the inventive cold-cure flexible foam siloxane formulation and/or cold-cure flexible foam activator solution have the following advantages:
sufficient stabilization of the foam,
stabilization against the influences of shear forces,
stabilization of the edge zone and of the skin,
control of cell size and of cell size distribution, and avoidance of an elevated closed-cell content.

Water-insoluble polysiloxane compounds used with preference have a maximum of 70 silicon atoms per polysiloxane molecule, preferably a maximum of 50 silicon atoms, more preferably 5 to 25 silicon atoms, polydimethylsiloxanes having 5 to 25 silicon atoms in the molecule being the most preferable.

The suitable polydimethylsiloxanes have a low viscosity. It has been found that polydimethylsiloxanes having a viscosity of >200 mPas, in a disadvantageous manner, disrupt the formation of a very regular cell structure. Especially viscosities of >500 mPas or higher lead to an unwanted irregular sponge-like cell structure, or even to the collapse of the foam. According to the present invention, preference is therefore given to polydimethylsiloxanes of the general formula (III) in which all R, R¹ radicals are methyl radicals and m=0, which have a viscosity of ≧0 mPa.s to ≦100 mPa.s, preferably a viscosity of ≧0.5 mPa.s to ≦80 mPa.s, more preferably a viscosity of ≧1 mPa.s to ≦70 mPa.s and especially preferably a viscosity of ≧1.5 mPa.s to ≦50 mPa.s.

The viscosity, unless stated otherwise in the description of the present invention, was measured to DIN 53015 at 20° C. with a falling ball viscometer according to Höppler.

The viscosity of the cold-cure flexible foam siloxane formulation is in the range from 20 mPa.s to 10 000 mPa.s, measured at 20° C. according to Höppler.

When the formulation is in the form of an emulsion, the size distribution of the oil droplets present is such that more than 90% by volume of the oil droplets are smaller than 2 μm or smaller than 1 μm or smaller than 0.5 μm. The size distribution was measured with a particle size measuring instrument from Beckman Coulter, model “LS 230”, by the principle of laser diffraction. Or, in the case of particularly fine emulsions, the method of dynamic light scattering (DLS) is used. In addition, a microscope image which depicts at least 10×10 droplets can be evaluated by counting.

The aqueous cold-cure flexible foam siloxane formulation is notable for a very good stability. For instance, the inventive cold-cure flexible foam siloxane formulation is storage-stable at room temperature and does not form any droplet coalescence and a resulting phase separation, for example, over a period of at least 10 days, preferably of at least 50 days and more preferably of at least 100 days. In the case that creaming or sedimentation occurs, this can generally be eliminated again by simply stirring without employing high shear forces.

A particular advantage of the inventive aqueous cold-cure flexible foam siloxane formulation is that it can be incorporated into an activator solution to obtain a storage-stable, homogeneous activator solution. Known stabilizers based on water-insoluble siloxanes, for example TEGOSTAB® B 4113 LF, obtainable from Evonik Goldschmidt, cannot, however, be used to produce homogeneous activator solutions.

Frequently, all constituents apart from the polyols and isocyanates are mixed before foaming to give the activator solution. This then comprises, inter alia, the siloxanes (stabilizers), the catalysts, such as amines, metal catalysts and the blowing agent, for example water, and any further additives, such as flame retardants, dyes, biocides, etc., according to the formulation of the foam.

It has now been found that, surprisingly, it is easily possible to produce a homogeneous activator solution without additional cost and inconvenience when the inventive cold-cure flexible foam siloxane formulation is mixed with a composition comprising:
catalysts, preferably amines, metal catalysts,
optionally physical blowing agents, preferably acetone, methylene chloride,
additional water as a chemical blowing agent,
optionally flame retardants, UV stabilizers, dyes, biocides, pigments, cell openers, crosslinkers, other foam-stabilizing substances and customary additives, which are required for production and use of the foam.

A preferred inventive homogeneous cold-cure flexible foam activator solution which is suitable for use in the production of highly elastic cold-cure flexible polyurethane foams comprises an inventive aqueous cold-cure flexible foam siloxane formulation and additives selected from the group comprising:
catalysts, preferably amines, metal catalysts,
optionally physical blowing agents, preferably acetone, methylene chloride,
additional water as a chemical blowing agent, and optionally additives selected from the group comprising flame retardants, UV stabilizers, dyes, biocides, pigments, cell openers, crosslinkers, other foam-stabilizing substances and customary processing aids.

The cold-cure flexible foam activator solution may additionally comprise all customary additives known in the prior art for activator solutions.

To produce a cold-cure flexible polyurethane foam, a mixture of polyol, polyfunctional isocyanate, amine activator, tin catalysts or zinc catalysts or other metal catalysts, stabilizer, blowing agent, preferably water for formation of CO₂ and, if necessary, addition of physical blowing agents, optionally with addition of flame retardants, UV stabilizers, color pastes, biocides, fillers, crosslinkers or other customary processing aids, is converted.

The polyols used may be all polyols which are suitable for production of cold-cure flexible foams, in the manner familiar to the person skilled in the art. Some examples of suitable polyols are mentioned in U.S. Pat. No. 4,477,601, EP 0499200 and the documents cited therein.

In particular, high-reactivity polyols are used. These are preferably trifunctional polyols which, in addition to a high molecular weight of typically between about 4800 and 6500 g/mol, have at least 70% up to 95% primary hydroxyl groups, and so the OH number thereof is between 36 and 26 mg KOH/g. These polyols are formed from up to 90% propylene oxide, but contain almost exclusively primary OH groups resulting from the addition of ethylene oxide. The primary OH groups are much more reactive toward the isocyanate groups than the secondary OH groups of the polyols used for the production of hot-cure flexible polyurethane foam, the OH numbers of which at molecular weights between 3000 and 4500 g/mol are typically between 56 and 42 mg KOH/g.

A further class of high-reactivity polyols is that of the filled polyols (polymer polyols). These are notable in that they contain solid organic fillers up to a solids content of 40% or more in disperse distribution. Those used include:
SAN polyols: these are high-reactivity polyols which contain a copolymer based on styrene/acrylonitrile (SAN) in dispersed form.
PHD polyols: these are high-reactivity polyols which contain polyurea, likewise in dispersed form.
PIPA polyols: these are high-reactivity polyols which contain a polyurethane, formed, for example, by in situ reaction of an isocyanate with an alkanolamine in a conventional polyol, in dispersed form.

The formulations containing solids-containing polyols may have distinctly lower intrinsic stability and therefore require not only chemical stabilization by the crosslinking reaction but generally also physical stabilization in addition.

According to the solids content of the polyols, they are used alone or in a blend with the abovementioned unfilled polyols.

The isocyanates used may be organic isocyanate compounds which contain at least two isocyanate groups. In general, the aliphatic, cycloaliphatic, araliphatic and preferably aromatic polyvalent isocyanates known per se are useful. Particular preference is given to using isocyanates within a range from 60 to 140 mol % relative to the sum of the isocyanate-consuming components.

Both TDI (tolylene 2,4- and 2,6-diisocyanate isomer mixture) and MDI (4,4′-diphenylmethane diisocyanate) are used. “Crude MDI” or “polymeric MDI” contains, as well as the 4,4′ isomer, also the 2,4′ and 2,2′ isomers and higher polycyclic products. “Pure MDI” refers to bicyclic products formed from predominantly 2,4′ and 4,4′ isomer mixtures, or prepolymers thereof. Further suitable isocyanates are detailed in the patents DE 444898 and EP 1095968, which are fully incorporated here by reference.

The blowing agents are distinguished between chemical and physical blowing agents. The chemical blowing agents include water, the reaction of which with the isocyanate groups leads to the formation of CO₂. The density of the foam can be controlled by the amount of water or blowing agent added, the preferred amounts of water used being between 1.5 and 5.0 parts by mass, based on 100.0 parts by mass of polyol. In addition, it is possible alternatively and/or else additionally to use physical blowing agents, such as carbon dioxide, acetone, hydrocarbons such as n-, iso- or cyclopentane, cyclohexane, halogenated hydrocarbons such as methylene chloride, tetrafluoroethane, pentafluoropropane, heptafluoropropane, pentafluorobutane, hexafluorobutane and/or dichloromonofluoroethane. The amount of the physical blowing agent is preferably in the range between 1 and 15 parts by weight, especially 1 and 10 parts by weight, and the amount of water preferably in the range between 0.5 and 10 parts by weight, especially 1 and 5 parts by weight. Among the physical blowing agents, carbon dioxide is preferred, and is preferably used in combination with water as a chemical blowing agent.

The invention further provides highly elastic cold-cure flexible polyurethane foams produced using compositions comprising the inventive particulate emulsifiers. The present invention further relates to a product comprising a highly elastic cold-cure flexible polyurethane foam, which is produced using the aqueous cold-cure flexible foam siloxane formulation and/or the cold-cure flexible foam activator solution.

The invention further provides, for example, a car seat comprising the highly elastic cold-cure flexible polyurethane foam, which is produced using the aqueous cold-cure flexible foam siloxane formulation and/or the cold-cure flexible foam activator solution.

Further subject matter of the invention is described by the claims, the disclosure-content of which is fully incorporated into this description.

The subject matter of the present invention is explained further by the examples which follow.

### EXAMPLES

The examples adduced serve merely for illustration, but do not restrict the subject matter of the invention in any way.

The inventive compositions and the corresponding processes for production thereof are described by way of example hereinafter, though the invention cannot be considered to be restricted to these illustrated embodiments.

When ranges, general formulae or compound classes are specified hereinafter, these shall include not only the appropriate ranges or groups of compounds mentioned explicitly, but also all sub-ranges and sub-groups of compounds which can be obtained by selecting individual values (ranges) or compounds.

Unless stated otherwise, percentage or parts figures in the examples which follow are in each case figures by mass.

Production of inventive aqueous cold-cure flexible foam siloxane formulations:

The water-insoluble siloxane used was a polydimethyl-siloxane as described in DE 25 33 074 A1, example 4, as mixture 1.

### Example 1

188 g of dimineralized water and 37.8 g of LUDOX SM-AS (solids content 25% in water, product from Grace Division) was initially charged in a flask and adjusted to pH 7 with HCl. The neutralized sol was then preliminarily emulsified together with 50 g of siloxane in a vacuum dissolver with a mizer disk at 5000 rpm for 30 min. 7.5 g of a 5% aqueous CTAB solution (cetyltrimethylammonium bromide) were added to this preliminary emulsion, then the mixture was emulsified in a membrane pump vacuum at room temperature with a mizer disk at 5000 rpm for a further 30 min. The emulsion thus obtained was homogenized by means of passage through a homogenizer with an interaction chamber of diameter 200 μm at pressure 800 bar.

Subsequently, the mixture was admixed with 150 g of water containing, as a thickener, 0.3 g of Tego® Carbomer 141 (obtainable from Evonik Goldschmidt).

### Example 2

Procedure as in example 1, except that 25.2 g of LUDOX SM-AS and 5 g of a 5% aqueous CTAB solution were used.

After passage through the homogenizer, the mixture was admixed with 170 g of water containing 0.34 g of Tego® Carbomer 141 (obtainable from Evonik Goldschmidt).

### Example 3

Procedure as in example 1, except that 12.6 g of LUDOX SM-AS and 2.5 g of a 5% CTAB solution were used. After passage through the homogenizer, the mixture was admixed with 200 g of water containing 0.4 g of TEGO® Carbomer 141 (obtainable from Evonik Goldschmidt).

### Example 4

60 g of the emulsion produced in example 3 were mixed with 72 g of water containing 0.1 g of TEGO® Carbomer 141 (obtainable from Evonik Goldschmidt), and 18 g of a water-soluble siloxane as described in DE 19808581 as stabilizer comparison 3, to obtain a stable mixture.

### Comparative Example 1

### Anhydrous Siloxane Composition

30 g of siloxane were mixed with 270 g of dioctyl phthalate to form a homogeneous solution.

### Example 5

(Production of an activator solution) 7 g of the emulsion produced in example 3 were mixed with 9.45 g of water containing 0.02 g of TEGO® Carbomer 141 (obtainable from Evonik Goldschmidt), 3.5 g of diethanolamine, 2.8 g of TEGOAMIN® 33, 0.7 g of TEGOAMIN® BDE, 1.05 g of KOSMOS 29 and 21 g of Ortegol 204 from Evonik Goldschmidt, to obtain a stable mixture.

### Comparative Example 2

(Production of an activator solution)

7 g of the mixture produced in comparative example 1 were mixed with 15.75 g of water containing 0.02 g of TEGO® Carbomer 141 (obtainable from Evonik Goldschmidt), 3.5 g of diethanolamine, 2.8 g of TEGOAMIN® 33, 0.7 g of TEGOAMIN® BDE, 1.05 g of KOSMOS 29 and 21 g of Ortegol 204 from Evonik Goldschmidt. A mixture was obtained, which, after 2 hours, showed the first signs of a phase separation and, after 12 hours, had separated completely into 2 phases.

Example 5 and comparative example 2 show that activator solutions can be produced only with the inventive siloxane formulations.

### Example 6

Procedure as in example 1, except that 12.6 g of LUDOX SM-AS and 2.5 g of a 5% CTAB solution were used. After passage through the homogenizer, the mixture was admixed with 160 g of water containing 0.3 g of TEGO® Carbomer 141 (obtainable from Evonik Goldschmidt), and 40 g of ethanol.

This gave a stable emulsion which did not exhibit any inhomogeneities even after storage at −20° C. for 48 h and subsequent warming to room temperature.

### Example 7

Procedure as in example 1, except that 12.6 g of LUDOX SM-AS and 2.5 g of a 5% CTAB solution were used. After passage through the homogenizer, the mixture was admixed with 160 g of water containing 0.3 g of TEGO® Carbomer 141 (obtainable from Evonik Goldschmidt), and 40 g of polyethylene glycol 12000 (obtainable from Clariant) as a cell opener. This gave a stable emulsion.

Production of cold-cure flexible polyurethane foams:

Formulation A: 100 parts of polyol having an OH number of 35 mg KOH/g and a molar mass of 5000 g/mol, 2.25 parts of water, 0.5 part of diethanolamine, 0.4 part of TEGOAMIN® 33, 0.1 part of TEGOAMIN® BDE, 0.15 part of KOSMOS 29 and 3 parts of Ortegol 204 from Evonik Goldschmidt as a crosslinker and 40 parts of isocyanate (T80=tolylene 2,4- and 2,6-diisocyanate isomer mixture in a ratio of 80:20).

Formulation B: 60 parts of polyol having an OH number of 35 mg KOH/g and a molar mass of 5000 g/mol, 40 parts of the PHD polyol with solids content 20% and OH number 29 mg KOH/g and molar mass 6000 g/mol, 4 parts of water, 1.5 parts of diethanolamine, 0.5 part of TEGOAMIN® 33 and 0.07 part of TEGOAMIN® BDE and 48 parts of isocyanate (T80).

Production of slabstock foam with formulation A:

The foams were produced in the known manner, by mixing all components except isocyanate in a beaker, then adding the isocyanate and stirring it in rapidly at high stirrer speed. Then the reaction mixture was introduced into a paper-lined vessel with a base area of 28×28 cm. The height of rise and the settling were determined. The escape of blowing gases from the foam was assessed with values of 0-3, with 0 for poor or undetectable escape and 3 for very strong escape, the aim being values of 1-2.

“Settling” refers to the decrease in the height of rise in cm 1 minute after attainment of the maximum height of rise.

“Escape” refers to the escape of the blowing gases from the opened cells of the foam.

### Example 8

(Using the activator solution from example 5)

In accordance with formulation A, a foam was produced using 6.5 parts of the activator solution produced in example 5 per 100 parts of polyol and 40 parts of isocyanate.

The foam obtained had a good stability. With a height of rise of 21.5 cm, the settling was 0.8 cm. The escape performance was rated as 1. The cell count was 10-11 cells/cm.

### Example 9

The stabilizer used was the aqueous cold-cure flexible foam siloxane formulation from example 1, and the amount of water present therein was included in the foam formulation. The aqueous cold-cure flexible foam siloxane formulation was used in such an amount that there was 0.1 part of water-insoluble polysiloxane per 100 parts of polyol.

The foam obtained had a good stability. At a height of rise of 21.8 cm, the settling was 0.5 cm. The escape performance was rated as 1. The cell count was 10-11 cells/cm.

### Example 10

The stabilizer used was the aqueous cold-cure flexible foam siloxane formulation from example 2, and the amount of water present therein was included in the foam formulation. The aqueous cold-cure flexible foam siloxane formulation was used in such an amount that there was 0.1 part of water-insoluble polysiloxane per 100 parts of polyol. The foam obtained had a good stability. At a height of rise of 21.4 cm, the settling was 1.1 cm. The escape performance was rated as 1. The cell count was 10-11 cells/cm.

### Example 11

The stabilizer used was the aqueous cold-cure flexible foam siloxane formulation from example 3, and the amount of water present therein was included in the foam formulation. The aqueous cold-cure flexible foam siloxane formulation was used in such an amount that there was 0.1 part of water-insoluble polysiloxane per 100 parts of polyol. The foam obtained had a good stability. At a height of rise of 22.5 cm, the settling was 0.4 cm. The escape performance was rated as 1. The cell count was 11 cells/cm.

### Comparative Example 3

The stabilizer used was the nonaqueous cold-cure flexible foam siloxane formulation from comparative example 1, and the amount of water present therein was included in the foam formulation. The cold-cure flexible foam siloxane formulation was used in such an amount that there was 0.1 part of water-insoluble polysiloxane per 100 parts of polyol. The foam obtained had a good stability. At a height of rise of 21 cm, the settling was 1.0 cm. The escape performance was rated as 1. The cell count was 11 cells/cm.

The examples show that no quality losses in foam production occur with the inventive stabilizer formulations, and hence the production of industrially usable foam qualities is possible.

Examples in a molded foam, formulation B:

The foams were produced in the known manner by mixing all components except from the isocyanate in a beaker, then adding the isocyanate and stirring it in rapidly at high stirrer speed. Then the reaction mixture was introduced into a cuboidal mold which had been heated to a temperature of 60° C., and the mixture was allowed to cure for 6 minutes. Subsequently, the forces applied were measured. This was done by compressing the foams to 50% of their height 10 times. This was followed by (manual) application of full force in order then to be able to determine the hardness of the pressed foam in the 11th measurement. Then the foams were cut open to assess the skin and edge zone, and to determine the cell count.

### Example 12

In accordance with formulation B, 1 part of the formulation from example 3 was used per 100 parts of the polyol mixture and 48 parts of isocyanate to produce a molded foam, with appropriate adjustment of the amount of water.

The forces applied were as follows: 1st measurement: 1862 N, 10th measurement: 160 N, 11th measurement: 157 N. The skin and edge zone did not exhibit any faults. The cell count was 11 cells/cm.

### Example 13

In accordance with formulation B, 1 part of the formulation from example 4 was used per 100 parts of the polyol mixture and 48 parts of isocyanate to produce a molded foam, with appropriate adjustment of the amount of water.

The forces applied were as follows: 1st measurement: 2012 N, 10th measurement: 213 N, 11th measurement: 165 N. The skin and edge zone did not exhibit any faults. The cell count was 11 cells/cm.

### Example 14

In accordance with formulation B, 1 part of the formulation from example 7 was used per 100 parts of the polyol mixture and 48 parts of isocyanate to produce a molded foam, with appropriate adjustment of the amount of water.

The forces applied were as follows: 1st measurement: 1678 N, 10th measurement: 159 N, 11th measurement: 157 N. The skin and edge zone did not exhibit any faults. The cell count was 11 cells/cm.

The examples show that it is also possible to use the inventive stabilizer formulations to produce molded foams without quality losses. In addition, use of cell openers, in example 7, can reduce the force applied.

1. An aqueous cold-cure flexible foam siloxane formulation comprising water-insoluble polysiloxane compounds for use in the production of highly elastic cold-cure polyurethane foams, characterized in that the formulation is stabilized using particles which are nanoscale or nanostructured in at least one dimension.

2. A cold-cure flexible foam activator solution based on aqueous cold-cure flexible foam siloxane formulations as claimed in claim 1, comprising further assistants and additives except the polyol and isocyanate components which are required to produce cold-cure flexible polyurethane foams.

3. The cold-cure flexible foam siloxane formulation as claimed in claim 1, characterized in that it has a maximum proportion of water and water-insoluble polysiloxane compound.

4. The cold-cure flexible foam siloxane formulation as claimed in claim 3, characterized in that the sum of water-insoluble polysiloxane compound and water is greater than 50% by weight based on the overall composition.

5. The composition as claimed in claim 1, characterized in that the emulsifiers used are particles which are nanoscale and/or nanostructured in at least one dimension.

6. The composition as claimed in claim 1, characterized in that the particulate emulsifiers are selected from the group of the semimetal oxides, metal oxides, mixed oxides, nitrides, carbides, hydroxides, carbonates, silicates, silicone resins, silicones and/or silica, and/or organic polymers, where all of these particle classes mentioned may optionally be hydrophobized or partly hydrophobized.

7. The composition as claimed in claim 1, characterized in that the particulate emulsifier has a mean primary particle size in at least one dimension of less than ≦1000 nm.

8. The composition as claimed in claim 1, characterized in that further functional substances or surface-active substances are additionally used.

9. The composition as claimed in claim 1, characterized in that the composition comprises water-insoluble polysiloxanes in the form of a particulate emulsion (o/w).

10. The composition as claimed in claim 1, which is free of nonparticulate emulsifiers.

11. The composition as claimed in claim 1, which comprises nonparticulate emulsifiers in contents of >0 to less than 10% by weight.

12. The composition as claimed in claim 1, which comprises 0 to 10% by weight of a coemulsifier.

13. The composition as claimed in claim 12, comprising, as coemulsifiers, cationic, amphoteric, anionic or nonionic, surface-active substances.

14. The composition as claimed in claim 1, characterized in that the coemulsifiers used are one or more substances selected from the group of the compounds or formulations VARISOFT 470 P, VARISOFT TC-90, VARISOFT 110, VARISOFT PATC, AROSURF TA-100, ADOGEN 442-100 P, ADOGEN 432, ADOGEN 470, ADOGEN 471, ADOGEN 464, VARIQUAT K 300, VARIQUAT B 343, VARIQUAT 80 ME, REWOQUAT 3690, REWOQUAT WE 15, REWOQUAT WE18, REWOQUAT WE 28 or REWOQUAT CR 3099, cetyltrimethylammonium bromide or chloride, VARISOFT 300, sodium laurylsulfate, sodium lauryl ether sulfate, sulfosuccinates, REWOPOL SB DO 75, alkyl ether phosphates, fatty acid anions, n-acylamino acids, olefinsulfonates or alkylbenzene-sulfonates.

15. The composition as claimed in claim 1, characterized in that further functional substances selected from the group of the antifreezes, organic solvents, thickeners, biocides, UV stabilizers, cell openers or reaction accelerators are added to the particulate emulsions.

16. A process for producing a particulate emulsion as claimed in claim 1, characterized in that the particulate emulsifier is processed together with the liquid components using shear forces.

17. The process for producing particulate emulsions as claimed in claim 16, characterized in that a preliminary emulsion consisting of:
a mixture of siloxanes which are aqueous cold-cure flexible foam siloxane formulation comprising water-insoluble polysiloxane compounds for use in the production of highly elastic cold-cure polyurethane foams and is free of nonparticulate emulsifiers,
water and
particles which are nanoscale and/or nanostructured in at least one dimension is produced in a step a1), to which a coemulsifier is optionally added in a step a2), said coemulsifier being added as a pure substance or in the form of a solution, for example of an aqueous solution, and said particles being partly hydrophobized and covering the interface between the inner and outer phases of the preliminary emulsion, and then the preliminary emulsion thus obtained from step a2) and optionally subsequently in step a3) being dispersed in a homogenizer.

18. The process for producing an aqueous cold-cure flexible foam siloxane formulation as claimed in claim 16 for use in the production of cold-cure flexible polyurethane foams or for use in the production of cold-cure flexible foam activator solutions for cold-cure polyurethane foams, as claimed in claim 2, characterized in that the aqueous cold-cure flexible foam siloxane formulation comprises the following components:
a) ≧0.1% by weight to ≦80% by weight of at least one water-insoluble polysiloxane compound having a molecular weight of at least ≧300 g/mol and ≦10 000 g/mol,
b) 2% by weight to 99% by weight of water,
c) 0.05% by weight to 40% by weight of solid-state emulsifier,
d) ≧0% by weight to 25% by weight of functional substances, and
e) optionally ≧0% by weight to 80% by weight of water-soluble siloxane(s),
where the proportion by weight of the aforementioned components is selected such that the total proportion by weight of the components is not more than 100% by weight, based on the aqueous cold-cure flexible foam siloxane formulation.

19. The cold-cure flexible foam siloxane composition as claimed in claim 18, comprising
a) 0.1% by weight to 80% by weight of at least one water-insoluble polysiloxane compound having a molecular weight of ≦10 000 g/mol and having the following general formula (I) 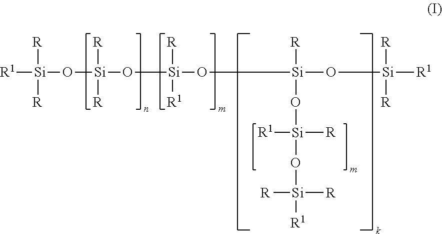
in which
R=identical or different linear, branched, unsaturated or saturated hydrocarbyl radicals having 1 to 50 carbon atoms,
R¹=R, OH, identical or different linear, branched, unsaturated or saturated hydrocarbyl radicals having 1 to 100 carbon atoms, containing at least one heteroatom selected from the group of N, S, O, P, F, Cl, Br and/or I,
n=≧0 to 50,
m=≧0 to 50,
k=≧0 to 10,
b) 2% by weight to 99% by weight of water,
c) 0.05% by weight to 40% by weight of solid-state emulsifier,
d) ≧0% by weight to 25% by weight of functional substances, and
e) optionally ≧0% by weight to 80% by weight of water-soluble siloxane(s),
with the proviso that n+m≧2 and n+m≦70, where the proportion by weight of the aforementioned components is selected such that the total proportion by weight of the components is not more than 100% by weight, based on the aqueous cold-cure flexible foam siloxane formulation.

20. The cold-cure flexible foam siloxane formulation as claimed in claim 19, which comprises at least one water-insoluble polysiloxane compound of the general formula (I), in which
R are identical or different alkyl or aryl radicals,
n is 1 to 50,
m is ≧1 to 20,
k is ≧1 to 10.

21. A highly elastic cold-cure flexible polyurethane foam produced using compositions comprising particulate emulsifiers as claimed in claim 1.

22. A product comprising a highly elastic cold-cure flexible polyurethane foam as claimed in claim 21, which has been produced using the composition which is an aqueous cold-cure flexible foam siloxane formulation comprising water-insoluble polysiloxane compounds for use in the production of highly elastic cold-cure polyurethane foams, characterized in that the formulation is stabilized using particles which are nanoscale or nanostructured in at least one dimension.

23. A car seat comprising a highly elastic cold-cure flexible polyurethane foam as claimed in claim 21.
